(19) United States
(12) Patent Application Publication
(10) Pub. No.: US 2008/0159724 A1
(43) Pub. Date: Jul. 3, 2008

(54) Method and system for inputting and displaying commentary information with content

(75) Inventors: Christopher Purvis, La Crescenta, CA (US); Kevin Rice, Altadena, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: Disney Enterprises, Inc.

(21) Appl. No.: 11/647,056

(22) Filed: Dec. 27, 2006

(51) Int. Cl. H04N 5/00

(52) U.S. Cl. 386/126

(57) ABSTRACT

There is provided a method for use by a media processing device to provide commentary information in conjunction with content stored in media. In one embodiment, playback of the content by the media processing device is begun. The playback is then stopped at a first time to receive commentary information. The commentary information entered by a user of the media processing device is then received. Thereafter, synchronization data used for synchronizing the content with the commentary information for providing the commentary information at the first time is generated. Then, the commentary information and the synchronization data are stored in memory. For example, the commentary information and the synchronization data can be transmitted to and stored in a database having memory.

### BACKGROUND OF THE INVENTION

1. Field of the Invention

The present invention relates generally to interactive media. More particularly, the present invention relates to inputting and displaying commentary information with content stored in media.

2. Background Art

Distributors of packaged media, such as DVD movies, typically include bonus features in the content to increase consumer demand and sales of the content. Such bonus features can include commentaries which can provide interesting facts about the content unknown to most viewers and can thus heighten the content viewing experience. However, the number of commentaries included in conventional packaged media is typically limited.

As such, consumers of packaged media are typically required to search various other resources, such as the Internet, magazines, newspapers, or television programs to acquire factual or entertaining commentaries and reviews of the content stored in the packaged media. For example, a person seeking commentaries relating to particular content can search various websites on the Internet for such commentaries or can read film and entertainment magazines and movie review sections in newspapers. Moreover, one may even view television programs which include discussions and critical reviews of content.

For example, a person searching for commentaries on the Internet can perform various searches using a search engine, e.g., Google, to find websites which may include the desired commentaries pertaining to the content. However, such searches can be very time consuming and difficult as each webpage must be perused one at a time to locate the desired commentaries and reviews. Furthermore, commentaries pertaining to less recent content may be difficult to find in current issues of magazines and newspapers. Television programs which provide such reviews of content are also less likely to cover less recent content and typically tend to cover only a limited variety of content.

Thus, there is a strong need in the art for a method and system that allows end users of packaged media to input and display commentary information with content.

### SUMMARY OF THE INVENTION

There is provided methods and systems for inputting and displaying commentary information with content, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a block diagram of a system for inputting and displaying commentary information with content in accordance with one embodiment of the invention.

FIG. 2 illustrates a block diagram of a system for displaying commentary information with content in accordance with one embodiment of the invention.

FIG. 3 illustrates a block diagram of a system for displaying commentary information with content in accordance with one embodiment of the invention.

FIGS. 4A and 4B show a flowchart of a method for inputting and displaying commentary information with content in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

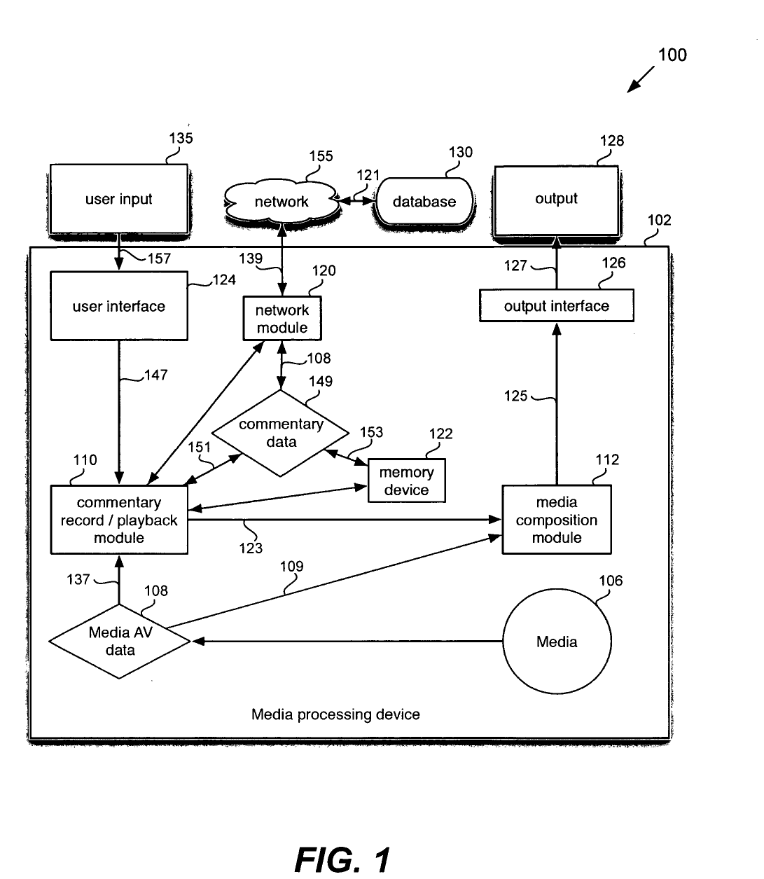

FIG. 1 illustrates a block diagram of a system for inputting and displaying commentary information with content in accordance with one embodiment of the invention. As shown in FIG. 1, system 100 includes media processing device 102, which includes, media 106, commentary record/playback module 110, media composition module 112, memory device 122, network module 120 and user interface 124.

Media processing device 102 in FIG. 1 can be, for example, a computer system with DVD playing capability, a digital media player, such as a Digital Video Disc (DVD) player, a High Definition Digital Video Disc (HD DVD) player, or a Blu-Ray Disc player, and can be configured to receive input from one or more input devices, such as a keyboard, a microphone, or a video camera (not shown in FIG. 1). Media processing device 102 can be used to play content stored in packaged media, such as media 106. As shown in FIG. 1, media processing device 102 includes media composition module 112, which is coupled to output interface 126 via data path 125. Output interface 126 can be configured to provide suitable audio and video signals to output display 128 via datapath 127, thereby allowing output display 128 to display content stored in media 106. Output display 128 can be, for example, a television or a computer monitor. As also shown in FIG. 1, user interface 124 can receive user input 135 via data path 157, which can enable a user to control media processing device 102. For example, user interface 124 can be used to begin and stop playback of content in media 106. User interface 124, for example, can be implemented in hardware or software.

Referring to FIG. 1, media 106 can be, for example, a DVD, an HD DVD, or Blu-Ray Disc. The content stored in media 106, i.e., media audio/video (A/V) data 108, can be provided to media composition module 112 via data path 109 for playback of the content. As shown in FIG. 1, media A/V data 108 can also be provided to commentary record/playback module 110 through data path 137. As further shown in FIG. 1, commentary record/playback module 110 interfaces with user interface 124, memory device 122, and network module 120.

Media processing device 102 can be configured by a user to play back content stored in media 106 in a mode which allows a user to input commentary information at desired times during playback. For example, a user may want to display some fact or trivia about a particular scene in the content. In such an example, the user may stop playback of the content at the time when the commentary information is to be displayed, e.g., at the particular scene in the content, and can input the commentary information through user interface 124. User interface 124 can include any one of a text and graphic input interface, an audio input interface, or a video input interface (not shown in FIG. 1). For example, the user may display the fact or trivia as text included in a graphic balloon e.g., a pop-up balloon, by inputting the required characters and images through a text and graphic input interface included in user interface 124. The text and graphic input interface may allow a user to input characters through a keyboard, an on-screen keypad, or other character selection mechanism. In one embodiment, the graphics input by a user can be animated. The text and graphic input interface can also allow a user to determine a display location at which the commentary information is to be displayed and a duration period for displaying the commentary information. Thus, the invention allows the user to momentarily superimpose text and graphics over content at desired times during playback of the content.

In another embodiment, the user may display the fact or trivia as audio by inputting audio data using an audio input interface included in user interface 124. For example, the audio input interface can receive audio data from a microphone (not shown in FIG. 1) coupled to media processing device 102. Accordingly, the user may simply speak into the microphone to create a supplemental audio track that can be heard, for example, over the standard audio track of the content. As another example, the audio input interface can be configured to access audio data stored in memory device 122 through commentary record/playback module 110. The audio data can include music and other sound effects to achieve a desired effect.

In yet another embodiment, the user may display the fact or trivia as a video by inputting a video clip, for example, using a video input interface included in user interface 124. For example, video input interface can receive video data from a camera (not shown in FIG. 1) coupled to media processing device 102. Thus, the user may create a video that can be displayed, for example, in a small window displayed simultaneously with the content. The video input interface can also allow a user to determine a display location where the small window will be displayed.

As shown in FIG. 1, media processing device 102 can also be configured to receive content at network module 120 via data path 139 in the form of a content stream. For example, a user may purchase content, such as a movie or a television program, from a content provider on the Internet, which can be streamed to the user from the content provider. In such an embodiment, media processing device 102 can allow a user to receive the content and replay the content in a mode which allows the user to stop playback and to enter comments as described above.

Once the commentary information is inputted by the user, e.g., through user interface 124, commentary record/playback module 110 can receive the commentary information through data path 147 and can generate synchronization data associated with the received commentary information. For example, the synchronization data can contain a time or scene location at which the commentary information is to be displayed during playback of the content. The synchronization data can also contain information indicating a size, display location, and duration of the commentary information. For example, if the commentary information inputted by a user is an image containing text, such as a pop-up balloon, the synchronization data can include the time at which the commentary information was inputted, i.e., the time at which playback of the content was stopped to input the commentary information, such that the commentary information can be displayed precisely at that time during playback of the content. Moreover, the synchronization data can also indicate the display location of where the image is to be displayed, the size of the image, and the duration for displaying the image.

As shown in FIG. 1, commentary record/playback module 110 can be further configured to generate commentary data, such as commentary data 149, which includes the commentary information and the associated synchronization data inputted by a user for the content stored in media 106. The commentary data can then be transmitted via data paths 151 and 153 and stored in memory device 122 in media processing device 102. Thus, the invention allows a user to create and store commentary data for the content stored in media 106. For example, the commentary data might include commentary information including only audio data or a number of images containing text, such as pop-up balloons. Commentary record/player module 110 in FIG. 1 can be configured to receive commentary data containing commentary information and synchronization data and to display the commentary information as indicated by the synchronization data during playback of the content stored in media 106.

As shown in FIG. 1, media processing device 102 can be configured to access database 130 through network 155 using network module 120. For example, network module 120 can be an Ethernet adapter or other suitable network adapter. Data paths 121 and 139, for example, can be wired connections, such as physical communication buses, or wireless connections, such as wireless local area network (LAN) connections. For example, database 130 can be configured to receive, store, and distribute commentary data. Thus, in one embodiment of the invention, a user may use media processing device 102 to transmit commentary data stored in memory device 122 to database 130. In another embodiment, the media processing device may be configured to receive commentary data stored in database 130 by another user through data paths 121 and 139 and to store the commentary data in memory device 122. Although FIG. 1 shows only one media processing device, i.e., media processing device 102, it should be noted that database 130 can be accessed by a number of media processing devices through their respective network modules and data paths.

Media processing device 102 can be configured to play back commentary data along with content using commentary record/playback module 110. As shown in FIG. 1, commentary record/playback module 110 can provide commentary data to media composition module 112 via data path 123. As also shown in FIG. 1, media composition module 112 can receive media A/V data 108 via data path 109. As such, media composition module 112 can display the commentary information at the appropriate times during playback of the content by, for example, combining the commentary information and media A/V data 108 to generate modified media A/V data. The modified media A/V data can then be transmitted to output interface 126 via data path 125, which can then enable output display 128 to display the content with the commentary information.

Thus, a user of media processing device 102 in FIG. 1 can view the content, e.g., a motion picture, stored in media 106 and can insert a number graphical images and text, for example, which can be stored as commentary data and can be replayed along with the content by the user or by other users who have access to the commentary data. As such, a user who wants other users to view her commentary data can transmit her commentary data to database 130 shown in FIG. 1. Conversely, a user may access database 130 and search through the commentary data created by other users and replay the commentary data along with the content. For example, a user may log into a website, such as “DisneyMovieReview.com,” which may offer the user a large selection of commentary data pertaining to various Disney movies. The user may then download the commentary data for a particular movie created, for example, by author “A” and playback the commentary data along with the movie. If the user particularly enjoys the commentary data created by author “A,” she can search the database for other commentary data prepared by author “A” and download and view the commentary data in a similar manner. Thus, the invention allows a convenient and efficient way to share commentaries with other users. In addition, commentary data can also be shared with other users through a Web log (“blog”). For example, a user may suggest or post commentary data via a blog, which may then be downloaded by others having access to the blog.

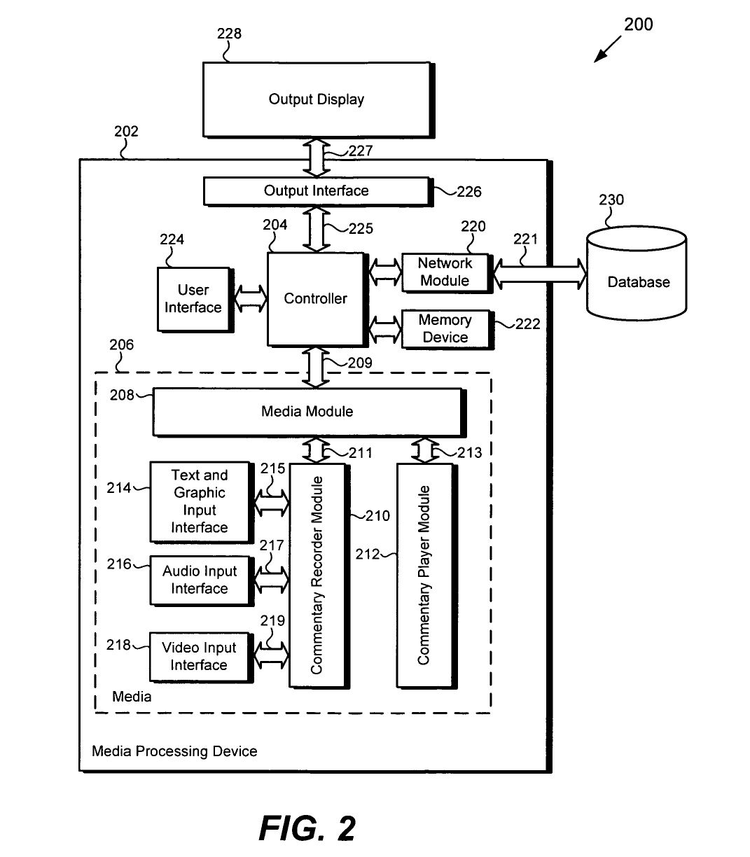

FIG. 2 illustrates a block diagram of a system for inputting and displaying commentary information with content in accordance with one embodiment of the invention. As shown in FIG. 2, system 200 includes media processing device 202, which includes controller 204, memory device 222, network module 220 and user interface 224. System 200 further includes media 206, which includes media module 208, commentary recorder module 210 and commentary player module 212.

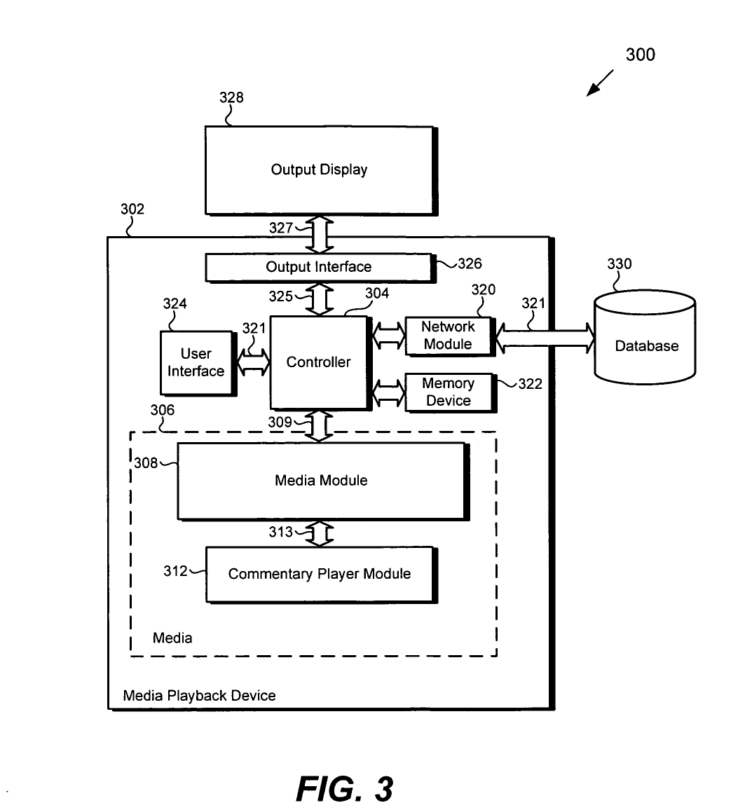

Media processing device 202 in FIG. 2 can be, for example, a computer system with DVD playing capability, a digital media player, such as a Digital Video Disc (DVD) player, a High Definition Digital Video Disc (HD DVD) player, or a Blu-Ray Disc player, and can be configured to receive input from one or more input devices, such as a keyboard, a microphone, or a video camera (not shown in FIG. 3). Media processing device 202 can be used to play content stored in packaged media, such as media 206. As shown in FIG. 2, media processing device 202 includes controller 204, which is coupled to output interface 226 via data path 225. Controller 204 can be a microcontroller, for example, or can be a controller implemented in software. Output interface 226, which corresponds to output interface 126 in FIG. 1, can be configured to allow output display 228, which corresponds to output display 128 in FIG. 1, to display content stored in media 206. As also shown in FIG. 2, controller 204 is coupled to user interface 224, which can enable a user to control media processing device 202. For example, user interface 224 can be used to begin and stop playback of content in media 206. User interface 224, for example, can be implemented in hardware or software.

Referring to FIG. 2, media 206 can be, for example, a DVD, an HD DVD, or Blu-Ray Disc. Media 206 can store content in media module 208 and can provide the content to controller 204 via data path 209 for playback of the content. As shown in FIG. 2, media module 208 in media 206 interfaces with commentary recorder module 210 and commentary player module 212 through respective data paths 211 and 213. As further shown in FIG. 2, commentary recorder module 210 interfaces with text and graphic input interface 214, audio input interface 216, and video input interface 218, which can each be implemented in hardware or software.

Media processing device 202 can be configured by a user to play back content stored in media module 208 in a mode which allows a user to input commentary information at desired times during playback. For example, a user may want to display some fact or trivia about a particular scene in the content. In such an example, the user may stop playback of the content at the time when the commentary information is to be displayed, e.g., at the particular scene in the content, and can input the commentary information through either text and graphic input interface 214, audio input interface 216, or video input interface 218. For example, the user may display the fact or trivia as text included in a graphic balloon e.g., a pop-up balloon, by inputting the required characters and images using text and graphic input interface 214. Text and graphic input interface 214 may allow a user to input characters through a keyboard, an on-screen keypad, or other character selection mechanism. In one embodiment, the graphics input by a user can be animated. Text and graphic input interface 214 can also allow a user to determine a display location at which the commentary information is to be displayed and a duration period for displaying the commentary information. Thus, the invention allows the user to momentarily superimpose text and graphics over content at desired times during playback of the content.

In another embodiment, the user may display the fact or trivia as audio by inputting audio data using audio input interface 216. For example, audio input interface 216 can receive audio data from a microphone (not shown in FIG. 2) coupled to media processing device 202. Accordingly, the user may simply speak into the microphone to create a supplemental audio track that can be heard, for example, over the standard audio track of the content. As another example, audio input interface 216 can be configured to access audio data stored in memory device 222. The audio data can include music and other sound effects to achieve a desired effect.

In yet another embodiment, the user may display the fact or trivia as a video by inputting a video clip, for example, using video input interface 218. For example, video input interface 218 can receive video data from a camera (not shown in FIG. 2) coupled to media processing device 202. Thus, the user may create a video that can be displayed, for example, in a small window displayed simultaneously with the content. The video input interface can also allow a user to determine a display location where the small window will be displayed.

Media processing device 202 can also be configured to receive content via network module 220 in the form of a content stream. For example, a user may purchase content, such as a movie or a television program, from a content provider on the Internet, which can be streamed to the user from the content provider. In such an embodiment, media processing device 202 can allow a user to receive the content and replay the content in a mode which allows the user to stop playback and to enter comments as described above.

Once the commentary information is inputted by the user, e.g., through text and graphic input interface 214, audio input interface 216, or video input interface 218, commentary recorder module 210 can receive the commentary information through an appropriate data path, e.g., data path 215, 217, or 219, and can generate synchronization data associated with the received commentary information. For example, the synchronization data can contain a time or scene location at which the commentary information is to be displayed during playback of the content. The synchronization data can also contain information indicating a size, display location, and duration of the commentary information. For example, if the commentary information inputted by a user is an image containing text, such as a pop-up balloon, the synchronization data can include the time at which the commentary information was inputted, i.e., the time at which playback of the content was stopped to input the commentary information, such that the commentary information can be displayed precisely at that time during playback of the content. Moreover, the synchronization data can also indicate the display location of where the image is to be displayed, the size of the image, and the duration for displaying the image.

Commentary recorder module 210 can be further configured to generate a commentary file that contains all of the commentary information and associated synchronization data inputted by a user for the content stored in media 206. The commentary file can then be stored in memory device 222 in media processing device 202. Thus, the invention allows a user to create and store multiple commentary files for the content stored in media 206. For example, one commentary file might include commentary information including only audio data while another commentary file might include a number of images containing text, such as pop-up balloons. Commentary player module 212 in FIG. 2 can be configured to receive a commentary file containing commentary information and synchronization data and to display the commentary information as indicated by the synchronization data during playback of the content stored in media module 208.

As shown in FIG. 2, media processing device 202 can be configured to use network module 220 to access database 230 via data path 221. For example, network module 220 can be an Ethernet adapter or other suitable network adapter. Data path 221, for example, can be a wired connection, such as a physical communication bus, or a wireless connection, such as a wireless local area network (LAN) connection. For example, database 230 can be configured to receive, store, and distribute a number of the abovementioned commentary files. Thus, in one embodiment of the invention, a user may use media processing device 202 to transmit one or more commentary files stored in memory device 222 to database 230. In another embodiment, the media processing device may be configured to receive a commentary file stored in database 230 by another user through data path 221 and to store the commentary file in memory device 222. Although FIG. 1 shows only one media processing device, i.e., media processing device 202, it should be noted that database 230 can be accessed by a number of media processing devices through their respective network modules and data paths.

FIG. 3 illustrates a block diagram of a system for displaying commentary information with content in accordance with one embodiment of the invention. As shown in FIG. 3, system 300 includes media playback device 302, which includes controller 304, memory device 322, network module 320, and user interface 324. System 300 further includes media 306, which includes media module 308 and commentary player module 312. In particular, controller 304, memory device 322, network module 320, user interface 324, media module 308, and commentary player module 312 in FIG. 3 correspond to controller 204, memory device 222, network module 220, user interface 224, media module 208, and commentary player module 212 in FIG. 2, respectively.

Media playback device 302 in FIG. 3 can be, for example, a digital media player, such as a Digital Video Disc (DVD) player, a High Definition Digital Video Disc (HD DVD) player, or a Blu-Ray Disc player. Media playback device 302 can be used to play content stored in packaged media, such as media 306. Media 306 can be, for example, a DVD, an HD DVD, or Blu-Ray Disc. Media 306 can store content in media module 308 and can provide the content to controller 304 via data path 309 for playback of the content. As shown in FIG. 3, media module 308 in media 306 interfaces with commentary player module 312 via data path 313. As also shown in FIG. 3, media playback device 302 includes controller 304, which is coupled to output interface 326 via data path 325. Output interface 326 can be configured to provide suitable audio and video signals to output display 328 via data path 327, thereby allowing output display 328 to display content stored in media 306. As further shown in FIG. 3, controller 304 is coupled to user interface 324, which can enable a user to control media playback device 302.

As shown in FIG. 3, media playback device 302 can use network module 320 to access database 330 via data path 321. Data path 321, for example, can be a wired connection, such as a physical communication bus, or a wireless connection, such as a wireless local area network (LAN) connection. Although FIG. 3 shows only one media playback device, i.e., media playback device 302, it should be noted that database 330 can be accessed by a number of media playback devices through their respective network modules and data paths. Database 330 can store a number of the abovementioned commentary files that are transmitted to database 330 by other users. Each commentary file in database 330 can be identified by the name of the author or by a classification that indicates the type of commentary information included, such as “humor” or “non-fiction.”

Commentary player module 312 can provide an interface which enables a user of media playback device 302 to select a commentary file to be displayed with the content stored in media module 308. In one embodiment, commentary player module 312 can enable a user to search through various commentary files stored in database 330 using the name and/or classification given to each commentary file. Once the desired commentary file is determined, commentary player module 312 can access database 330 via data path 321 to retrieve the commentary file. For example, commentary player module 312 can allow several commentary files to be retrieved from database 330 and stored in memory device 322. The user can then select a commentary file to be displayed with the content through the interface provided by commentary player module 312. In another embodiment, commentary player module 312 can be configured to randomly retrieve commentary files available in database 330 and thus enable the user to display various commentary information from multiple authors.

The selected commentary files to be displayed with the content can be provided by controller 304 to media module 308 via data path 309. The commentary files can then be loaded in commentary player module 312 via data path 313. Commentary player module 312 can then process the commentary files to determine the commentary information and synchronization data contained therein. Once the user begins playback of the content, commentary player module can provide the commentary information to media module 308 via datapath 313, thereby allowing the commentary information to be displayed at the appropriate times during playback of the content.

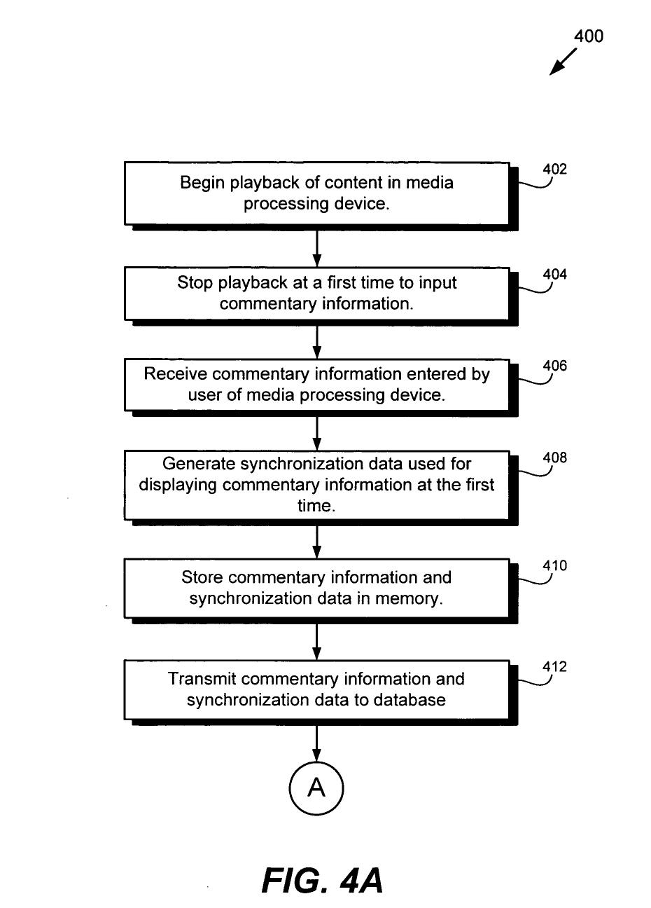

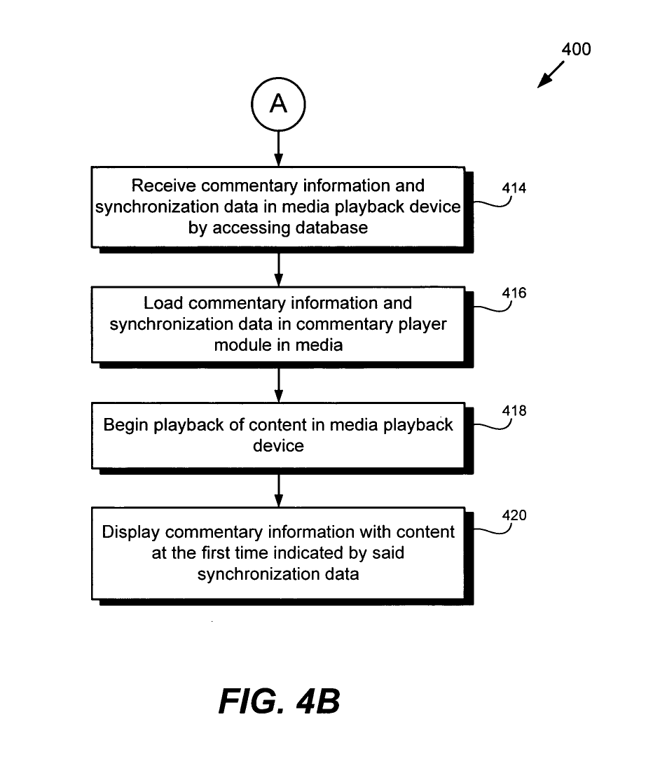

FIGS. 4A and 4B show a flowchart for performing method 400 for inputting and displaying commentary information with content in accordance with one embodiment of the invention. As shown in FIG. 4A and with reference to FIG. 2, at step 402 of flowchart 400, playback of content in media processing device 202 is begun. At step 404, playback is stopped by the user at a first time to input commentary information. At step 406, commentary information entered by the user of media processing device 202 is received. At step 408, synchronization data used for displaying the commentary information at the first time is generated. At step 410, the commentary information and synchronization data are stored in memory, such as memory device 222. At step 412, the commentary information and the synchronization data are transmitted to database 230.

Thereafter, as shown in FIG. 4B and with reference to FIG. 3, at step 414 of flowchart 400, commentary information and synchronization data are received in media playback device 302 by accessing database 330. At step 416, the commentary information and synchronization data are loaded in commentary player module 312 in media 306. At step 418, playback of content in media playback device 302 is begun. At step 420, the commentary information is displayed with the content at the first time indicated by the synchronization data.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a media processing device to provide commentary information in conjunction with content stored in media, said method comprising:
beginning playback of said content by said media processing device;
stopping playback at a first time to receive commentary information;
receiving said commentary information entered by a user of said media processing device;
generating synchronization data used for synchronizing said content with said commentary information for providing said commentary information at said first time;
storing said commentary information and said synchronization data in a memory.

2. The method of claim 1 further comprising transmitting said commentary information and said synchronization data to a database having said memory over a network.

3. The method of claim 1 wherein said commentary information is one of an image, text, audio, or video.

4. The method of claim 1 wherein said synchronization data includes information indicating a size, position, and duration of said commentary information.

5. The method of claim 1 wherein said receiving is performed by a commentary recorder module included in said media, wherein said commentary recorder module is configured to receive commentary information through a plurality of interfaces.

6. The method of claim 5 wherein each of said plurality of interfaces can be one of a text and graphic input interface, an audio input interface, or a video input interface.

7. The method of claim 1 wherein said media is a one of a Digital Video Disc (DVD), a High-Definition Digital Video Disc (HD DVD), or a Blu-Ray Disc.

8. A method for use by a media playback device to provide commentary information in conjunction with content stored in media, said method comprising:
receiving said commentary information and synchronization data;
loading said commentary information and said synchronization data;
beginning playback of said content in said media playback device;
playing said commentary information in synchronization with playing back said content according to said synchronization data.

9. The method of claim 8 wherein said receiving is performed by accessing a database over a network.

10. The method of claim 8 wherein said receiving is performed by accessing a memory device in said media playback device.

11. The method of claim 8 wherein said commentary information is one of an image, text, audio, or video.

12. The method of claim 8 wherein said synchronization data includes information indicating a size, position, and duration of said commentary information.

13. The method of claim 8 wherein said loading is performed by providing said commentary information and said synchronization data to a commentary player module included in said media.

14. The method of claim 8 wherein said media is a one of a Digital Video Disc (DVD), a High-Definition Digital Video Disc (HD DVD), or a Blu-Ray Disc.

15. A system for providing commentary information in conjunction with content stored in media, said system comprising:
a media processing device configured to play said content stored in said media;
a commentary recorder module configured to receive said commentary information entered by a user, wherein said commentary recorder module is further configured to generate synchronization data used to synchronize said commentary information with said content;
a memory device for storing said commentary information and said synchronization data;
a commentary player module configured to provide said commentary information in synchronization with playing back said content according to said synchronization data.

16. The system of claim 15 wherein said media processing device includes a network module, wherein said media processing device uses said network module to access a database including said commentary information and said synchronization data.

17. The system of claim 15 wherein said media includes said commentary recorder module and said commentary player module.

18. The system of claim 15 wherein said commentary information is one of an image, text, audio, or video.

19. The system of claim 15 wherein said synchronization data contains information indicating a size, position, and duration of said commentary information.

20. The system of claim 15 wherein said media is a one of a Digital Video Disc (DVD), a High-Definition Digital Video Disc (HD DVD), or a Blu-Ray Disc.
